(19) United States
(12) Patent Application Publication
(10) Pub. No.: US 2025/0225043 A1
(43) Pub. Date: Jul. 10, 2025

(54) CONTEXTUALIZED TASK-SPECIFIC GRAPHICAL VISUALIZATION RELATED TO THIRD-PARTY DATA SOURCES

(71) Applicant: Optum Inc., Minnetonka, MN (US)

(72) Inventors: Katrin Hänsel, New York, NY (US); Mohammod Mashfiqui Rabbi Shuvo, Bothell, WA (US); Nandini Nayar, New York, NY (US); Rony Krell, Brooklyn, NY (US); Sankalita Saha, Saratoga, CA (US); Hieu Trung Nguyen, Jackson Heights, NY (US)

(21) Appl. No.: 18/772,794

(22) Filed: Jul. 15, 2024

Related U.S. Application Data
(60) Provisional application No. 63/618,951, filed on Jan. 9, 2024.

(51) Int. Cl. G06F 11/32

(52) U.S. Cl. CPC G06F 11/323

(57) ABSTRACT

Various embodiments of the present disclosure provide a contextualized task-specific graphical visualization related to one or more third-party data sources. The techniques may include generating a defined data object by transforming a plurality of third-party data elements from one or more third-party data sources to a defined first-party format, generating a structured data object from the defined data object based on a data structure format comprising a set of format features defined by a machine learning formatting prompt, generating a task-specific data object from the structured data object and corresponding to a defined domain task by filtering a plurality of task-agnostic features of the structured data object using a task-specific prompt that defines a set of task-related features, and initiating a rendering of a contextualized task-specific graphical visualization that is based on the task-specific data object and comprises a set of interactive graphical elements for the defined domain task.

### CROSS-REFERENCE TO RELATED APPLICATIONS

This application claims the benefit of U.S. Provisional Application No. 63/618,951, entitled “CONTEXTUALIZED PATIENT HISTORY TIMELINE VISUALIZATION FROM VARIOUS RECORD SOURCES,” and filed Jan. 9, 2024, the entire contents of which are herein incorporated by reference.

### BACKGROUND

Various embodiments of the present disclosure address technical challenges related to ingesting, aggregating, managing, and/or transforming data from disparate data sources. Traditional data ingestion engines obtain datasets for data processing tasks related to a model such as, for example, a machine learning model, by repeatedly extracting data segments from disparate data sources for the data processing task. The extracted data segments are often not adequately formatted for a particular data processing task such as, for example, a machine learning task or an application programming interface (API) task for an electronic interface. As such, performing such data processing tasks using traditional data ingestion engines is time-consuming, resource intensive, and/or error prone. Various embodiments of the present disclosure make important contributions to traditional data ingestion engines and data processing techniques by addressing these technical challenges, among others.

### BRIEF SUMMARY

Various embodiments of the present disclosure provide data ingestion and/or data processing techniques that improve upon traditional data ingestion engines and/or traditional data processing techniques. To do so, some embodiments of the present disclosure provide a data processing pipeline that utilizes machine learning to ingest, aggregate, manage, and/or transform data from data sources. In some embodiments of the present disclosure, the data may be intelligently configured for a particular data processing task such as, for example, a machine learning task or an application programming interface (API) task for an electronic interface. The resulting data may be contextualized and/or formatted for rendering via an interactive electronic interface rendering. In some embodiments of the present disclosure, a contextualized task-specific graphical visualization related to one or more third-party data sources may be provided. This, in turn, enables an improved data processing pipeline integrated with machine learning that directly addresses technical challenges within the realm of traditional data ingestion engines and/or traditional data processing techniques, such as time-consuming ingestion of data, resource intensive transformation of data, and/or inaccurate datasets for data processing tasks, among others.

In some embodiments, a computer-implemented method includes generating, by one or more processors and using a plurality of first-party data ingestion protocols, a defined data object by transforming a plurality of third-party data elements from one or more third-party data sources to a defined first-party format. In some embodiments, the computer-implemented method additionally or alternatively includes generating, by the one or more processors and using a machine learning formatting model, a structured data object from the defined data object based on a data structure format comprising a set of format features defined by a machine learning formatting prompt. In some embodiments, the computer-implemented method additionally or alternatively includes generating, by the one or more processors and using a machine learning relevancy model, a task-specific data object from the structured data object and corresponding to a defined domain task by filtering a plurality of task-agnostic features of the structured data object using a task-specific prompt that defines a set of task-related features. In some embodiments, the computer-implemented method additionally or alternatively includes initiating, by the one or more processors and via a user interface, a rendering of a contextualized task-specific graphical visualization that is based on the task-specific data object and comprises a set of interactive graphical elements for the defined domain task.

In some embodiments, a computing system comprises memory and one or more processors that are communicatively coupled to the memory, the one or more processors are configured to generate, using a plurality of first-party data ingestion protocols, a defined data object by transforming a plurality of third-party data elements from one or more third-party data sources to a defined first-party format. In some embodiments, the one or more processors are additionally or alternatively configured to generate, using a machine learning formatting model, a structured data object from the defined data object based on a data structure format comprising a set of format features defined by a machine learning formatting prompt. In some embodiments, the one or more processors are additionally or alternatively configured to generate, using a machine learning relevancy model, a task-specific data object from the structured data object and corresponding to a defined domain task by filtering a plurality of task-agnostic features of the structured data object using a task-specific prompt that defines a set of task-related features. In some embodiments, the one or more processors are additionally or alternatively configured to initiate, via a user interface, a rendering of a contextualized task-specific graphical visualization that is based on the task-specific data object and comprises a set of interactive graphical elements for the defined domain task.

In some embodiments, one or more non-transitory computer-readable storage media includes instructions that, when executed by one or more processors, cause the one or more processors to generate, using a plurality of first-party data ingestion protocols, a defined data object by transforming a plurality of third-party data elements from one or more third-party data sources to a defined first-party format. In some embodiments, the instructions, when executed by the one or more processors, additionally or alternatively cause the one or more processors to generate, using a machine learning formatting model, a structured data object from the defined data object based on a data structure format comprising a set of format features defined by a machine learning formatting prompt. In some embodiments, the instructions, when executed by the one or more processors, additionally or alternatively cause the one or more processors to generate, using a machine learning relevancy model, a task-specific data object from the structured data object and corresponding to a defined domain task by filtering a plurality of task-agnostic features of the structured data object using a task-specific prompt that defines a set of task-related features. In some embodiments, the instructions, when executed by the one or more processors, additionally or alternatively cause the one or more processors to initiate, via a user interface, a rendering of a contextualized task-specific graphical visualization that is based on the task-specific data object and comprises a set of interactive graphical elements for the defined domain task.

### BRIEF DESCRIPTION OF THE DRAWINGS

FIG. 1 provides an example overview of an architecture in accordance with one or more embodiments of the present disclosure.

FIG. 2 provides an example predictive data analysis computing entity in accordance with some embodiments of the present disclosure.

FIG. 3 provides an example client computing entity in accordance with one or more embodiments of the present disclosure.

FIG. 4 is a dataflow diagram showing example data structures, modules, and/or pipelines for generating a contextualized task-specific graphical visualization in accordance with one or more embodiments discussed herein.

FIG. 5 provides an example dataflow diagram related to providing the data ingestion functionality associated with a data processing platform in accordance with one or more embodiments discussed herein.

FIG. 6 provides an example dataflow diagram related to providing machine learning formatting functionality associated with a machine learning platform in accordance with one or more embodiments discussed herein.

FIG. 7 provides another example dataflow diagram related to providing machine learning formatting functionality associated with a machine learning platform in accordance with one or more embodiments discussed herein.

FIG. 8 provides an example dataflow diagram related to providing user interface renderings associated with a data processing platform in accordance with one or more embodiments discussed herein.

FIG. 9 provides an example user interface related to a contextualized task-specific graphical visualization in accordance with one or more embodiments discussed herein.

FIG. 10 is a flowchart diagram of an example process for providing a contextualized task-specific graphical visualization related to one or more third-party data sources in accordance with one or more embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

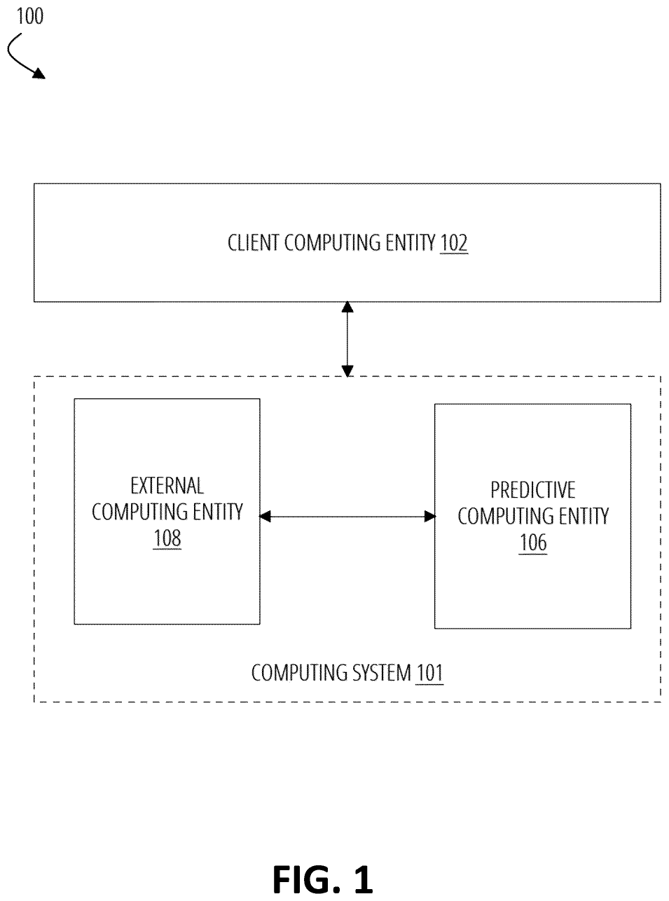

FIG. 1 provides an example overview of an architecture 100 in accordance with some embodiments of the present disclosure. The architecture 100 includes a computing system 101 configured to provide a data processing pipeline that utilizes machine learning to ingest, aggregate, manage, and/or transform data from data sources. In some embodiments, the computing system 101 may be configured to intelligently configure the data for a particular data processing task such as, for example, a machine learning task or an application programming interface (API) task for an electronic interface. The resulting data may be contextualized and/or formatted for rendering via an interactive electronic interface rendering. In some embodiments, the computing system 101 may be configured to generate a contextualized task-specific graphical visualization related to one or more third-party data sources. For example, the computing system 101 may generate a contextualized task-specific graphical visualization by: transforming intake data from one or more data sources into a defined output format, extracting task-specific information from the defined output format to provide a structured output format configured based on information provided via a prompt, filtering the structured output format based on domain knowledge information to provide a task-specific data object relevant to a defined task, and/or generating the contextualized task-specific graphical visualization based on the task-specific data object. The example architecture 100 may be used in a plurality of domains and not limited to any specific application as disclosed herewith. The plurality of domains may include healthcare, banking, industrial, manufacturing, education, retail, enterprise, to name a few.

In accordance with various embodiments of the present disclosure, one or more machine learning models may be trained to generate generative data such as, for example, one or more data objects. The models may form at least a portion of a data processing pipeline and/or a machine learning pipeline that may be configured to automatically generate a contextualized task-specific graphical visualization. This technique will lead to more accurate and reliable generative modeling techniques that may be efficiently used for a diverse set of different cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests and/or prompts from client computing entities 102, process the requests and/or prompts to generate outputs, such as generative data objects, and/or the like, and provide the generated data objects and/or a related visualization (e.g., a contextualized task-specific graphical visualization) to the client computing entities 102. For example, as discussed in further detail herein, the predictive computing entity 106 and/or one or more external computing entities 108 comprise storage subsystems that may be configured to store input data, data objects, training data, and/or the like that may be used by the respective computing entities to perform predictive data analysis, generative modeling, and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., generative data object techniques, classification techniques, simulation techniques, and/or the like) described herein. The external computing entities 108, for example, may include and/or be associated with one or more entities that may be configured to receive, transmit, store, manage, and/or facilitate datasets, such as one or more third-party data sources, and/or the like. The external computing entities 108, for example, may include data sources (e.g., third-party data sources) that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference and/or generative modeling steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

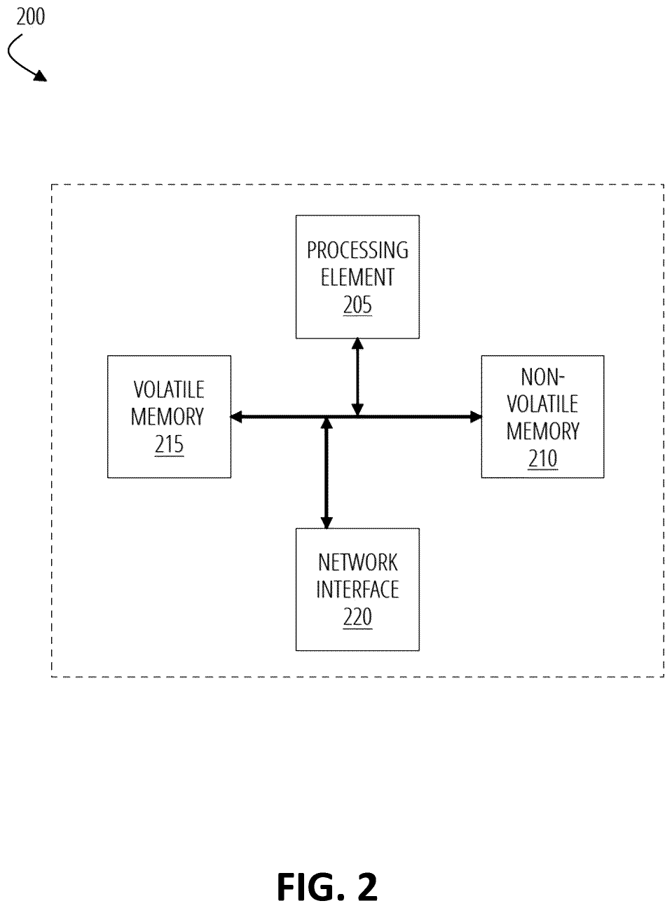

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

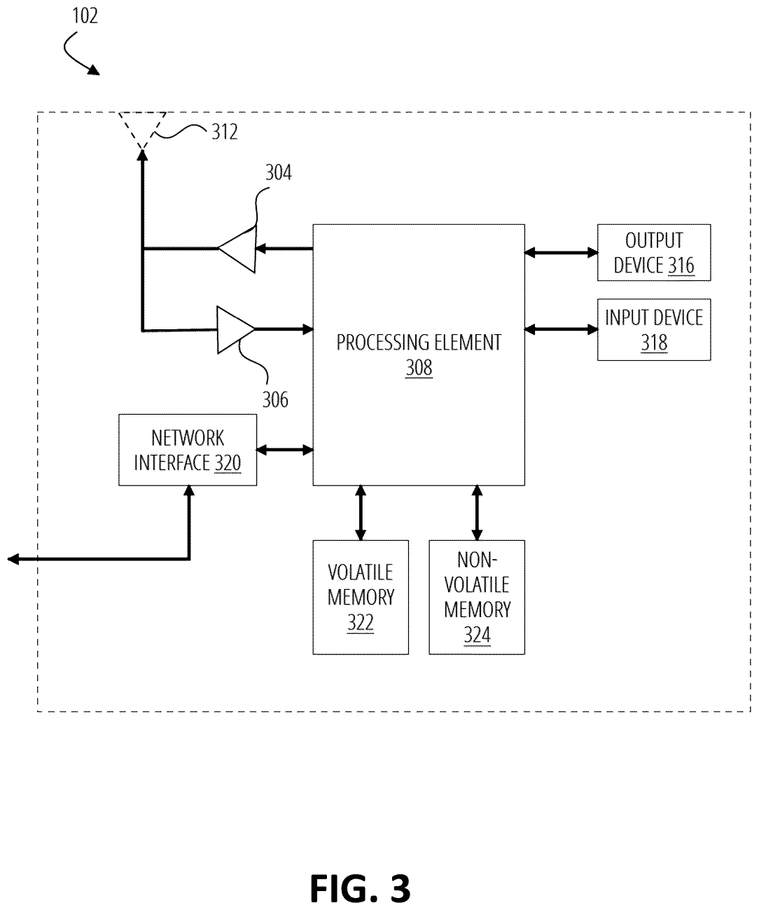

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an Al computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “first party” refers to a computing entity that is associated with a processing pipeline. The first party may include a computing system, platform, and/or device that is configured to digest, process, and/or leverage one or more third-party data sources. For example, the first party may include a first-party platform that is configured to digest, process, and/or leverage data from one or more disparate data sources to perform a computing action. In some embodiments, the data from the one or more disparate data sources may be accessible to the first party via a network. In some embodiments, the computing action may include machine learning, data filtering, and/or generating a contextualized visualization associated with the data. For example, the first-party platform may include a machine learning processing platform configured to facilitate the performance of one or machine learning models, a data processing platform configured to process, monitor, and/or aggregate large datasets, a user interface platform configured to initiate a rendering of a contextualized visualization associated with the data, and/or the like. To improve computing efficiency and enable the aggregation of data across multiple disparate datasets, the first party may utilize one or more first-party data ingestion protocols to generate a defined data object related to the data. For example, the first party may transform third-party data elements from one or more third-party data sources to a defined first-party format to facilitate the machine learning models, data processing, and/or rendering of data associated with the first-party platform. In some examples, the first party may utilize application programming interfaces (APIs) to ingest the data from one or more third-party data sources.

In some embodiments, the term “third-party data source” refers to a data storage entity configured to store, maintain, and/or monitor a data catalog. A third-party data source may include a heterogeneous data store that is configured to store a data catalog using specific database technologies. A data store, for example, may include a data repository, such a database, and/or the like, for persistently storing and managing collections of structured and/or unstructured data (e.g., catalogs, etc.). A third-party data source may include an on-premises data store including one or more locally curated data catalogs. In addition, or alternatively, a third-party data source may include a remote data store including one or more cloud-based data lakes. In some examples, a third-party data source may be built on specific database technologies that may be incompatible with one or more other third-party data sources. Each of the third-party data sources may define a data catalog that, in some use cases, may include data segments that could be aggregated to perform a computing task. In some embodiments, a third-party data source may be a health data source. For example, a third-party data source may be an electronic health record data source. In some embodiments, data from a third-party data source may be stored in a particular data formats such as, for example, JSON, XML, FIHR, PDF, and/or another type of data format. In some embodiments, data from a third-party data source may include collection of text data. For example, one or more portions of data from a third-party data source may correspond to a medical record. A medical record may contain information for claim lines in a case. A portion of a medical record for a particular claim line may be one paragraph or a set of keywords in the medical record.

In some embodiments, the term “defined data object” refers to a data entity that describes data from one or more third-party data sources. For example, a defined data object may refer to a data object that includes a plurality of third-party data elements from one or more third-party data sources. The data (e.g., the plurality of third-party data elements) may be formatted according to a defined output format to facilitate feature extraction and/or other data processing.

In some embodiments, the term “machine learning framework” refers to a data construct that describes parameters, hyperparameters, and/or defined operations of one or more machine learning models configured to generate a prediction output. In some embodiments, a machine learning framework may process data from one or more third-party data sources to provide a contextualized visualization related to the data. Additionally, a machine learning framework may include one or more machine learning models for providing machine learning with respect to the data.

In some embodiments, the term “machine learning model” refers to a data construct that describes parameters, hyperparameters, and/or defined operations configured to generate a prediction output using machine learning techniques. In some embodiments, a machine learning model is configured and/or trained to generate a data object that is formatted to optimize further machine learning, data processing, and/or rendering of data via a user interface. In some embodiments, a machine learning model is trained based on a particular domain task. The machine learning may include one or more of any type of machine learning model including one or more supervised, unsupervised, semi-supervised, reinforcement learning models, and/or the like. In some embodiments, a machine learning model may be configured as a large language model (LLM). An LLM may be a model that is configured, trained, and/or the like to generate natural language data and/or data object related therewith in response to a prompt. The LLM may include any type of LLM, such as a generative pre-trained transformer, and/or the like. Additionally or alternatively, a machine learning model may be configured as a neural network model, a deep learning model, a convolutional neural network (CNN) model, and/or another type of machine learning model related to a particular domain task.

In some embodiments, the term “machine learning formatting model” refers to a data construct that describes parameters, hyperparameters, and/or defined operations configured to generate a structured data object from a defined data object associated with a plurality of third-party data elements from one or more third-party data sources. The structured data object may be associated with a data structure format defined by a machine learning formatting prompt. For example, the data structure format may include a set of format features defined by a machine learning formatting prompt. In some embodiments, the machine learning formatting model is a generative machine learning model that is configured, trained, and/or the like to generate the structured data object in response to a prompt, such as the machine learning formatting prompt. For example, the machine learning formatting model may be configured as a LLM, a generative pre-trained transformer (GPT) model, or another type of generative machine learning model.

In some embodiments, the term “machine learning formatting prompt” refers to a data entity that represents at least a portion of a prompt provided to the machine learning formatting model. In some embodiments, the machine learning formatting prompt is a prompt data object generated based on real-time activity associated with a user interface. For example, the machine learning formatting prompt may include information provided by a user during one or more interactions with respect to a user interface of a user device. In some embodiments, the real-time activity is a real-time chatbot session associated with the machine learning formatting model. In some embodiments, the machine learning formatting prompt includes a request to generate a structured data object via a machine learning formatting model. In some embodiments, the machine learning formatting prompt is configured for communication via a network, an API, a machine learning model plug-in, and/or another type of interface between a user device and the machine learning formatting model.

In some embodiments, the term “machine learning relevancy model” refers to a data construct that describes parameters, hyperparameters, and/or defined operations configured to generate a task-specific data object from the structured data object. The task-specific data object may correspond to a defined domain task. Additionally, the task-specific data object may be a filtered version of the structured data object that is filtered using a domain knowledge profile for the defined domain task. For example, a plurality of task-agnostic features of the structured data object may be filtered to generate the task-specific data object. In some embodiments, the plurality of task-agnostic features of the structured data object may be additionally or alternatively filtered using a task-specific prompt that defines a set of task-related features. In some embodiments, the machine learning relevancy model is a generative machine learning model that is configured, trained, and/or the like to generate the task-specific data object in response to a prompt, such as the task-specific prompt. For example, the machine learning relevancy model may be configured as a LLM, a GPT model, or another type of generative machine learning model.

In some embodiments, the term “task-specific prompt” refers to a data entity that represents at least a portion of a prompt provided to the machine learning relevancy model. In some embodiments, the task-specific prompt is a prompt data object generated based on real-time activity associated with a user interface. For example, the task-specific prompt may include information related to task-related features that is provided by a user during one or more interactions with respect to a user interface of a user device. In some embodiments, the real-time activity is a real-time chatbot session associated with the machine learning relevancy model. In some embodiments, the task-specific prompt includes a request to generate a task-specific data object t via a machine learning relevancy model. In some embodiments, the task-specific prompt is configured for communication via a network, an API, a machine learning model plug-in, and/or another type of interface between a user device and the machine learning relevancy model.

In some embodiments, the term “contextualized task-specific graphical visualization” refers to an interactive rendering that is displayed via a user interface of a user device. In some embodiments, the contextualized task-specific graphical visualization includes a plurality of interactive graphical elements based on user interactions via the user interface. In some embodiments, the contextualized task-specific graphical visualization is configured as a contextualized patient history visualization for providing contextualized patient information via the user interface. For example, the contextualized task-specific graphical visualization may include an interactive timeline chart that visualizes gathered and filtered patient information from one or more third-party data sources in a contextualized manner for the patient. Additionally or alternatively, the contextualized task-specific graphical visualization may include medical information grouped into clinician-requested groups such as medications, diagnoses, lab markers, etc. where information for the clinician-requested groups are presented as a function of time. In some embodiments, the contextualized task-specific graphical visualization may allow a user to retrieve detailed information, such as, the source of the information, numeric values (e.g., for laboratory measures or medication dosage), and/or an explanation as to why the information is relevant to the condition of interest for the patient.

In some embodiments, the term “interactive graphical element” refers to a formatted version of one or more task-specific data objects to provide a visualization and/or human interpretation of data associated with the task-specific data objects via a user interface. In some embodiments, an interactive graphical element may additionally or alternatively be formatted based on an API protocol, user interface container rules, widget specifications, the like, or combinations thereof. In one or more embodiments, a selectable graphical element may include one or more graphical elements and/or one or more textual elements that may be selectable and/or otherwise interacted with via a user interface.

In some embodiments, the term “domain knowledge profile” refers to a data entity that describes a particular domain and/or entity. The domain knowledge profile may include a plurality of features corresponding to the particular domain and/or entity. In some examples, the domain knowledge profile may include a clinical knowledge profile identifying a plurality of clinical features corresponding to a particular clinical domain. In some examples, the plurality of features may be distributed across a plurality of different information channels. Each of the features may include one or more searchable attributes, such as text attributes that may be searched using keyword matching techniques, source embedding attributes that may be searched using embedding matching techniques, and/or the like.

In some embodiments, the term “domain knowledge datastore” refers to a dataset for a domain. For example, a domain knowledge datastore may include a comprehensive dataset that aggregates data from a plurality of disparate data sources associated with a domain. In some examples, the aggregated data may be stored in one or more different verticals to enable targeted retrieval and ingestion operations for accessing data. For example, the domain knowledge datastore may include data that is associated with a plurality of different sub-domains within a domain. In some examples, the data may be ingested through one or more different channels tailored to each of the sub-domains.

In some embodiments, the domain knowledge datastore includes different sets of data for different domains. For example, in a healthcare domain, a domain knowledge datastore may include a plurality of clinical knowledge data objects that correspond to one or more clinical domain profiles for one or more clinical domains. For example, the domain knowledge datastore may augment domain profiles with healthcare knowledge, machine learning techniques, and/or the like, such that each feature of a domain profile is searchable using natural language. In some embodiments, the domain knowledge datastore includes one or more models, such as the language model, a machine learning embedding model, and/or the like. The machine learning embedding model, for example, may be leveraged to generate a plurality of source embedding attributes to augment the features of the domain knowledge datastore. In some examples, the models may be accessible (e.g., through machine learning service APIs, etc.) to process a query for a clinical domain data object. In some examples, the domain knowledge datastore may include, for a healthcare domain, a plurality of clinical domain profiles, including clinical domain names, clinical domain types, medical information related to a clinical domain, relevant medical conditions related to a clinical domain, relevant medications related to a clinical domain, possible interactions for combining medications, and/or other miscellaneous information related to a clinical domain.

In some embodiments, the term “user identifier” refers to a data entity that identifies a user associated with a user device and/or a user interface. In some examples, a user identifier may be determined using information associated with a user device. For example, user device information, network address information, and/or other information included in a header portion, a data segment portion, metadata, or another portion of a user interface workflow may be correlated to a user identifier. In some embodiments, a user identifier is associated with a prompt (e.g., a machine learning formatting prompt and/or a task-specific prompt) for a machine learning model. In some embodiments, a user identifier is a patient identifier that corresponds to a patient and/or patient information associated with one or more third-party data elements and/or one or more third-party data sources.

### IV. Overview

Various embodiments of the present disclosure provide data ingestion and/or data processing techniques that improve upon traditional data ingestion engines and/or traditional data processing techniques. To do so, some embodiments of the present disclosure provide a data processing pipeline that utilizes machine learning to ingest, aggregate, manage, and/or transform data from data sources. In some embodiments of the present disclosure, the data may be intelligently configured for a particular data processing task such as, for example, a machine learning task or an API task for an electronic interface. The resulting data may be contextualized and/or formatted for rendering via an interactive electronic interface rendering. In some embodiments of the present disclosure, a contextualized task-specific graphical visualization related to one or more third-party data sources may be provided. This, in turn, enables an improved data processing pipeline integrated with machine learning that directly addresses technical challenges within the realm of traditional data ingestion engines and/or traditional data processing techniques, such as time-consuming ingestion of data, resource intensive transformation of data, and/or inaccurate datasets for data processing tasks, among others.

To ensure a uniform and/or properly formatted data object for the contextualized task-specific graphical visualization, some embodiments of the present disclosure provide a machine learning process that leverages machine learning prompts to directly tailor formatting, contextualization, and/or task-specific requirements for one or more data objects. As described herein, the specific data processing and machine learning techniques leveraged for generating one or more data objects enable a computer to perform a particular computing task that is traditionally unachievable and/or error prone using traditional data ingestion engines and/or traditional data processing techniques. In this manner, one or more data objects may be generated using prompts engineered for a specific computing task such that the one or more data objects may be automatically transformed into a rendering of the contextualized task-specific graphical visualization via a user interface. This, in turn, enables an improved data processing pipeline and/or an improved machine learning pipeline that directly addresses technical challenges within the realm of traditional data ingestion engines and/or traditional data processing techniques, such as time-consuming ingestion of data, resource intensive transformation of data, and/or inaccurate datasets for data processing tasks, among others.

In a non-limiting example related to a healthcare technology domain, various embodiments disclosed herein provide an improvement to traditional management of patient information stored in electronic health records. For example, traditional data ingestion engines of a healthcare computing system typically encounter several challenges for retrieving relevant and complete patient information from electronic health records where the vast amount of data is present in different data formats (e.g., structured forms, PDFs or images from lab reports, long free-text notes, etc.). To add to the data format complexity for the data ingestion engine, health data for a patient is often fragmented over various systems and/or data sources. Various embodiments disclosed herein therefore address the technical problems of aggregating fragmented data from various data sources to provide a contextualized profile for a patient. Various embodiments disclosed herein additionally address the technical problems of extracting medical information from different data formats to provide a contextualized profile for a patient. With the data processing pipeline disclosed herein that utilizes machine learning to ingest, aggregate, manage, and/or transform data from data sources, context-aware filtering and visual presentation of medical information may be provided to improve patient assessment and care provision. In some embodiments, the visual presentation of medical information may be configured as one or more disease-specific timeline charts for rendering via a user interface.

Examples of technologically advantageous embodiments of the present disclosure include: (i) data processing techniques such as, for example, data pre-processing techniques for improving data formatting of input data for machine learning, (ii) machine learning techniques for optimizing a data object for a rendering of a contextualized task-specific graphical visualization via a user interface, (iii) improved machine learning models, and training techniques thereof, for generating data objects, (iv) and improved data visualizations for contextually visualizing data stored in disparate data sources, among other aspects of the present disclosure. Other technical improvements and advantages may be realized by one of ordinary skill in the art.

### V. Example System Operations

As indicated, various embodiments of the present disclosure make important technical contributions to data processing and/or machine learning techniques. In particular, systems and methods are disclosed herein that implement machine learning techniques to improve data processing performance with respect to particular computing tasks. By doing so, generative data objects may be improved to expand the applicability of data processing techniques to task-specific use cases related to a contextualized task-specific graphical visualization. In some embodiments, the use of machine learning models may be configured for optimized data processing that is traditionally outside the scope of such models therefore resulting in an improvement to machine learning that is practically applied herein to address technical challenges with aggregating fragmented data across different data sources.

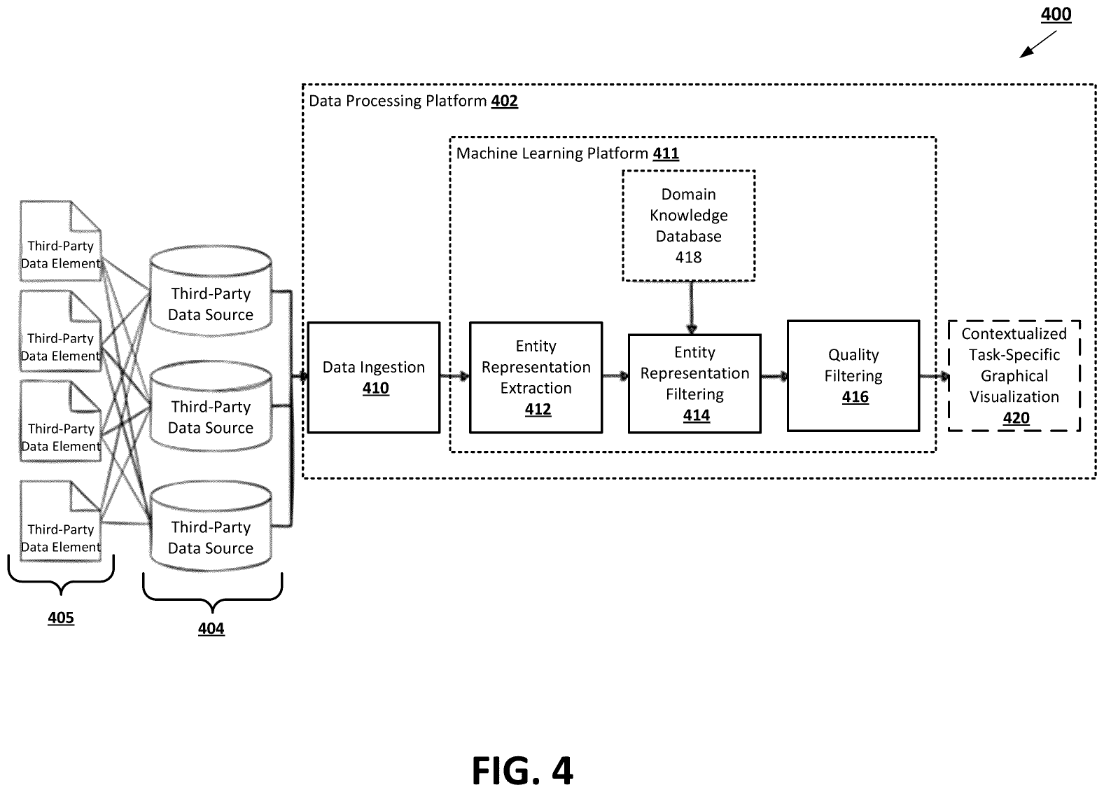

FIG. 4 is a dataflow diagram 400 showing example data structures, modules, and/or pipelines for generating a contextualized task-specific graphical visualization in accordance with some embodiments discussed herein. The dataflow diagram 400 includes a data processing platform 402 and one or more third-party data sources 404. In some embodiments, the one or more third-party data sources 404 are configured as one or more electronic health record data source. The one or more third-party data sources 404 may store a plurality of third-party data elements 405. In some embodiments, a third-party data element of the plurality of third-party data elements 405 may correspond to text and/or one or more images. In some embodiments, a third-party data element of the plurality of third-party data elements 405 may be configured in a particular data format such as, for example, PDF, JSON, XML, FHIR, JPEG, DICOM, PNG, TIFF, BMP, and/or another type of data format. In some embodiments, a third-party data element of the plurality of third-party data elements 405 May correspond to at least a portion of a lab report, a clinical note, a medical form, or another type of electronic health record.

The data processing platform 402 includes data ingestion 410 and a machine learning platform 411. In one or more embodiments, the machine learning platform 411 includes entity representation extraction 412, entity representation filtering 414, and/or quality filtering 416. In one or more embodiments, the data processing platform 402 and/or the machine learning platform 411 may correspond to a first-party platform with respect to the one or more third-party data sources 404. For example, the data processing platform 402 and/or the machine learning platform 411 may correspond to a first-party platform associated with functionality provide by the computing system 101 (e.g., the predictive computing entity 106). The data ingestion 410 may aggregate and/or import at least a portion of the plurality of third-party data elements 405 from the one or more third-party data sources 404 to facilitate machine learning associated with the machine learning platform 411. For example, the data ingestion 410 may aggregate and/or import at least a portion of the plurality of third-party data elements 405 from the one or more third-party data sources 404 to provide the portion of the plurality of third-party data elements 405 in a defined and/or consumable format for one or more machine learning processes associated with the machine learning platform 411. In some embodiments, the data ingestion 410 may be performed via an extract-transform-load (ETL) process. In some embodiments, the data ingestion 410 may utilize Object Character Recognition (OCR) to extract textual information from the plurality of third-party data elements 405. In some embodiments, the data ingestion 410 may transform at least a portion of the plurality of third-party data elements 405 into a defined first-party format for the machine learning platform 411. The defined first-party format may be configured in accordance with one or more data formatting requirements and/or data feature requirements for a defined data object. In some embodiments, the defined first-party format may retain information of a third-party data element of the plurality of third-party data elements 405 for backlinking (e.g., to link back a final output of the data processing platform 402 to the source material for traceability). In some embodiments, the defined data object associated with the defined first-party format may include source data, an element description of a third-party data source, timestamps, names of information, and/or metadata related to a third-party data element. In some examples, the metadata includes medication names, medication units, mediation dosage, lab result values, treatment names, laboratory marker numerical values, medical concept codes (e.g., ICD-10CM codes, Systematized Nomenclature of Medicine (SNOMED) codes, etc.), detailed free text notes, etc.

Based on the defined data object provided by the data ingestion 410, the machine learning platform 411 may perform one or more machine learning processes to generate a contextualized task-specific graphical visualization 420. In one or more embodiments, the entity representation extraction 412 may extract entity-specific information from the defined data object to provide a structured data object associated with a data structure format for further machine learning. The entity-specific information may be a portion of the data in the defined data object that is related to a particular entity such as, for example, a user identifier. In some embodiments, the structured data object may include event data related to a set of events for the particular entity. The events may be related to respective timestamps for the plurality of third-party data elements 405. In some embodiments, the entity representation extraction 412 may utilize a machine learning formatting model configured to extract the entity-specific information using artificial intelligence and/or machine learning. For example, the machine learning formatting model may be a LLM, a GPT model, or another type of machine learning model configured to extract the entity-specific information from the defined data object provided by the data ingestion 410. In some embodiments, the machine learning formatting model may be trained on a training dataset including information and/or features (e.g., medical information) related to a particular entity, domain, and/or computing task.

In some embodiments, the data structure format for the structured data object may be identified in one or more machine learning formatting prompts provided to the machine learning formatting model. For example, the one or more machine learning formatting prompts may include a set of format features for the structured data object. In some embodiments, the data structure format may be a tabular format. For example, the data structure format may be a tabular format where respective tabular data elements correspond to respective features for the entity-specific information. In some embodiments, the respective tabular data elements may be associated with a timepoint (e.g., a timestamp). In some embodiments, the respective tabular data elements may contain information related to a data entity, a type of the data entity (e.g., a laboratory marker, medication prescription, diagnosis, hospitalization status, etc.), a data source of a data entity event, a direct link to third-party data element information (e.g., a link to the third-party data element in a third-party data source or a file location of the third-party data element), a name of a data entity event, a description of a data entity event, numerical values associated with a data entity event, units associated with associated with a data entity event (e.g., laboratory markers, etc.), relevant source context (e.g., a free text note where information originates from, etc.).

Based on the structured data object provided by the entity representation extraction 412, the entity representation filtering 414 may perform one or more additional machine learning processes with respect to the structured data object to generate a task-specific data object from the structured data object. The task-specific data object may correspond to a defined domain task. In some embodiments, the defined domain task corresponds to a condition of interest (e.g., a medical condition of interest) for a patient. In one or more embodiments, the entity representation filtering 414 may filter the structured data object based on domain knowledge information stored in the domain knowledge database 418. In some embodiments, the domain knowledge information may include a set of domain keywords and/or other data related to domain knowledge for the defined domain task. In some embodiments, the domain knowledge information may be clinical knowledge information related to a particular clinical domain. In some embodiments, the entity representation filtering 414 may utilize a machine learning relevancy model configured to filter a plurality of task-agnostic features of the structured data object using artificial intelligence and/or machine learning. For example, the machine learning relevancy model may be a LLM, a GPT model, or another type of machine learning model configured to filter a plurality of task-agnostic features of the structured data object. In some embodiments, the machine learning relevancy model may be trained on a training dataset including information and/or features related to a particular domain (e.g., a particular clinical domain), a defined domain task, and/or computing task.

In some embodiments, the plurality of task-agnostic features for the filtering may be determined based on one or more task-specific prompts provided to the machine learning relevancy model. For example, the one or more task-specific prompts may include a set of task-related features for the filtering of the structured data object. The set of task-related features may be related to a specific domain task. In some embodiments, the set of task-related features may be related to a specific medical condition and/or defined clinical task. In some embodiments, respective portions of the event data of the structured output format may be assigned a binary label (e.g., a ‘relevant’ label or a ‘not relevant’ label) based on the set of task-related features. For example, the plurality of task-agnostic features for the filtering may be assigned a first label (e.g., a ‘not relevant’ label) such that, in response to the filtering, the task-specific data object may solely include data with a label corresponding to a second label (e.g., a ‘relevant’ label). In some embodiments, a label may be related to an entity relevant to a specific domain task. In some embodiments related to a defined clinical task, a label may be related to a specific medication (e.g., ‘diabetes medication’), a specific medication group name (e.g., ‘beta-blocker’), a specific laboratory marker type, a specific medical diagnosis, a specific medication procedure, or another type of clinical label. In some embodiments, respective portions of the event data of the structured output format may be assigned a label indicating relevancy to a specific domain task (e.g., a ‘beta-blocker,’ ‘diabetic medication,’ etc.) or a label indicating non-relevancy to specific domain task (e.g., a ‘not relevant’ label) based on the set of task-related features. For example, the plurality of task-agnostic features for the filtering may be assigned a non-relevancy label (e.g., a ‘not relevant’ label) such that, in response to the filtering, the task-specific data object may solely include data with a label corresponding to the set of the labels indicating relevancy to the specific domain task (e.g., a ‘beta-blocker,’ ‘diabetes medication,’, etc.). In some embodiments, a label may be additionally or alternatively related to a specific task associated with the contextualized task-specific graphical visualization 420.

In some embodiments, the quality filtering 416 may further filter the structured data object to further improve quality of the data in the structured data object for the defined domain task. For example, the quality filtering 416 may filter the plurality of task-agnostic features of the structured data object based on a set of data quality rules and/or set of duplication rules. The set of data quality rules may define one or more quality constraints for the one or more third-party data sources 404. The one or more quality constraints may correspond to a certain degree of weighting for data based on a method of entry of the data into the one or more third-party data sources 404. For example, certain types of data (e.g., laboratory values, etc.) that are manually entered into the one or more third-party data sources 404 may have a higher chance of being unreliable (e.g., containing typos) than other types of data (e.g., laboratory values from official laboratory reports). As such, the set of data quality rules may provide a quality weighting approach such that data that is automatically entered into the one or more third-party data sources 404 (e.g., laboratory blood sample reports, etc.) are filtered based on a first degree of weighting while other data that is manually entered into the one or more third-party data sources 404 (e.g., clinical notes, etc.) are filtered based on a second degree of weighting since information that has been manually entered in free-text notes or manually filled forms may indicate potential unreliable information.

The set of duplication rules may define one or more multi-tiered time-based constraints for the plurality of third-party data elements 405. The one or more multi-tiered time-based constraints may be related to a respective timestamp of the plurality of third-party data elements 405 and/or a date of entry of the plurality of third-party data elements 405 into the one or more third-party data sources 404. For example, the one or more multi-tiered time-based constraints may follow a multi-tiered approach for filtering where certain type of data duplicates for a particular interval of time (e.g., the exact same information such as same spelling, dosage, numerical values, etc. on the same day but from multiple sources) may be merged and/or two sources may be correlated for the data entry. In another example, the one or more multi-tiered time-based constraints may additionally or alternatively follow a multi-tiered approach for filtering where data entries for a particular interval of time (e.g., on the same day) that convey the same information but with non-trivial duplication (e.g., differing capitalization, use of abbreviations etc.) may be transformed into a uniform spelling (e.g., no abbreviation, normal capitalization, etc.) and/or may be marked as a duplicate in the contextualized task-specific graphical visualization 420 via a visual indicator (e.g., a highlight to indicate both data entries and/or both data sources). In yet another example, the one or more multi-tiered time-based constraints may additionally or alternatively follow a multi-tiered approach for filtering where conflicting information (e.g., different values for a task-related feature) for a particular interval of time (e.g., on the same day) may be weighted and/or provided with a visual indicator (e.g., a highlight) via the contextualized task-specific graphical visualization 420.

Based on the task-specific data object provided by the machine learning platform 411, the data processing platform 402 may generate the contextualized task-specific graphical visualization 420. For example, the contextualized task-specific graphical visualization 420 may be based on the task-specific data object and may include a set of interactive graphical elements for the defined domain task. Additionally, a rendering of the contextualized task-specific graphical visualization 420 may be initiated via a user interface. In some embodiments, the contextualized task-specific graphical visualization 420 may include an interactive timeline chart that visualizes all the gathered and filtered third-party data elements 405 in a contextualized manner for the defined domain task. In some embodiments, the contextualized task-specific graphical visualization 420 may be a contextualized patient history visualization that includes medical information grouped into clinician-requested groups such as medications, diagnoses, lab markers, etc. where information for the clinician-requested groups are presented as a function of time. In some embodiments, the contextualized task-specific graphical visualization 420 may also allow a user via a user interface to retrieve detailed information such as for example, the source of information related to a third-party data element, numeric values (e.g., for laboratory measures or medication dosage) related to a third-party data element, and/or an explanation as to why the information is relevant to the defined domain task.

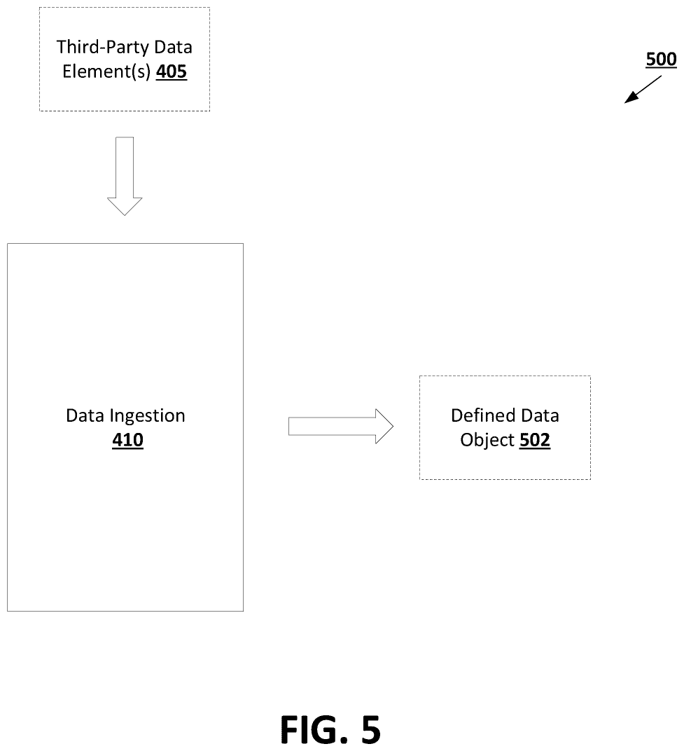

FIG. 5 illustrates an example dataflow diagram 500 related to providing the data ingestion functionality associated with the data processing platform 402, in accordance with one or more embodiments of the present disclosure. The dataflow diagram 500 includes the data ingestion 410. In one or more embodiments, the data ingestion 410 utilizes a plurality of first-party data ingestion protocols to generate a defined data object 502 by transforming at least a portion of the plurality of third-party data elements 405 from the one or more third-party data sources 404 to a defined first-party format. In some embodiments, the plurality of first-party data ingestion protocols may include one or more API protocols and/or one or more communication channel protocols for extracting least a portion of the plurality of third-party data elements 405 from the one or more third-party data sources 404. In some embodiments, the data ingestion 410 may utilize one or more data extraction techniques and/or one or more data transformation techniques related to cleaning, standardizing, normalizing, validating, and/or transforming the plurality of third-party data elements 405. The defined data object 502 may include at least a portion of the plurality of third-party data elements 405 that is formatted according to the functionality of the data ingestion 410. For example, the data ingestion 410 may load the transformed version of the portion of the plurality of third-party data elements 405 into the defined data object 502 according to a defined first-party format for the data processing platform 402.

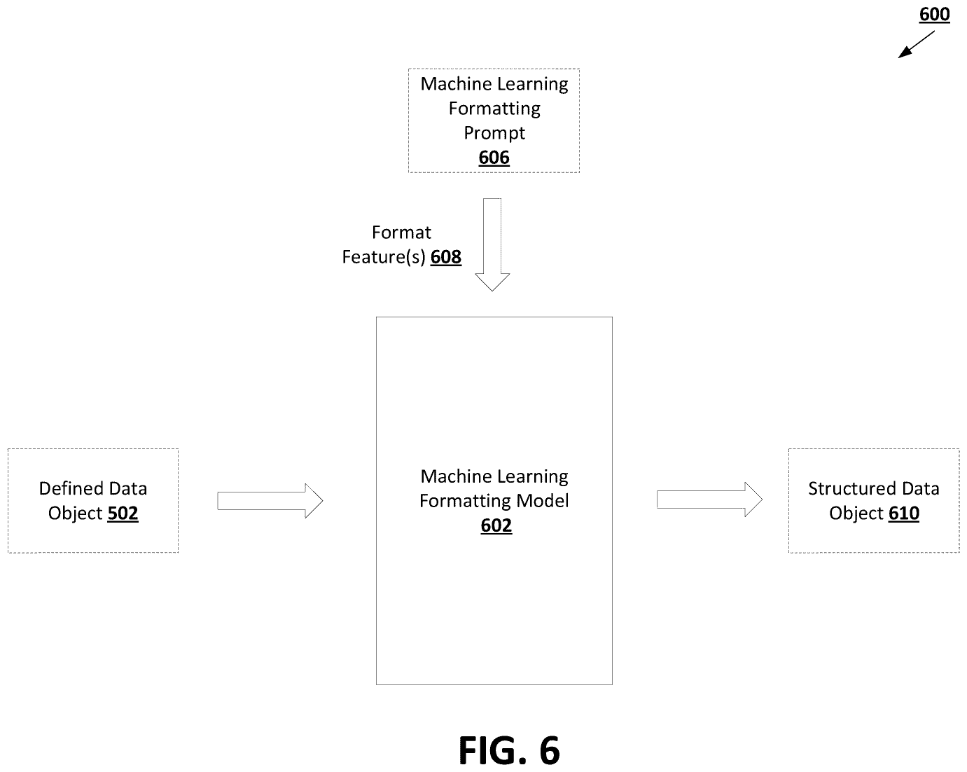

FIG. 6 illustrates an example dataflow diagram 600 related to providing machine learning formatting functionality associated with the machine learning platform 411, in accordance with one or more embodiments of the present disclosure. The dataflow diagram 600 includes the machine learning formatting model 602. In some embodiments, the entity representation extraction 412 may utilize the machine learning formatting model 602 to generate a structured data object 610 from the defined data object 502. In some embodiments, the machine learning formatting model 602 may generate the structured data object 610 based on a data structure format comprising a set of format features 608 defined by a machine learning formatting prompt 606. In some embodiments, the machine learning formatting prompt 606 is a prompt data object generated based on real-time activity associated with a user interface. For example, the machine learning formatting prompt 606 may include information provided by a user during one or more interactions with respect to a user interface of a user device. In some embodiments, the real-time activity is a real-time chatbot session associated with the machine learning formatting model 602. In some embodiments, the structured data object 610 includes a tabular format associated with respective timepoints for respective data elements of the structured data object 610.

In some embodiments, the machine learning formatting model 602 may be retrained based on one or more features associated with the structured data object 610. For example, one or more relationships between features mapped in the machine learning formatting model 602 may be adjusted (e.g., refitted) based on data associated with the structured data object 610. In another example, cross-validation, hyperparameter optimization, and/or regularization associated with the machine learning formatting model 602 may be adjusted based on one or more features associated with the structured data object 610.

In some embodiments, the machine learning formatting model 602 may additionally or alternatively extract entity-specific information from the defined data object 502 based on one or more non-machine learning techniques to provide the structured data object 610. For example, the machine learning formatting model 602 may additionally or alternatively utilize one or more deterministic techniques and/or one or more other non-machine learning techniques to transform one or more portions of the defined data object 502 into one or more portions of the structured data object 610. In some embodiments, the machine learning formatting model 602 may include and/or may be communicatively coupled to a different formatting model configured for one or more non-machine learning techniques such as, for example, one or more deterministic techniques.

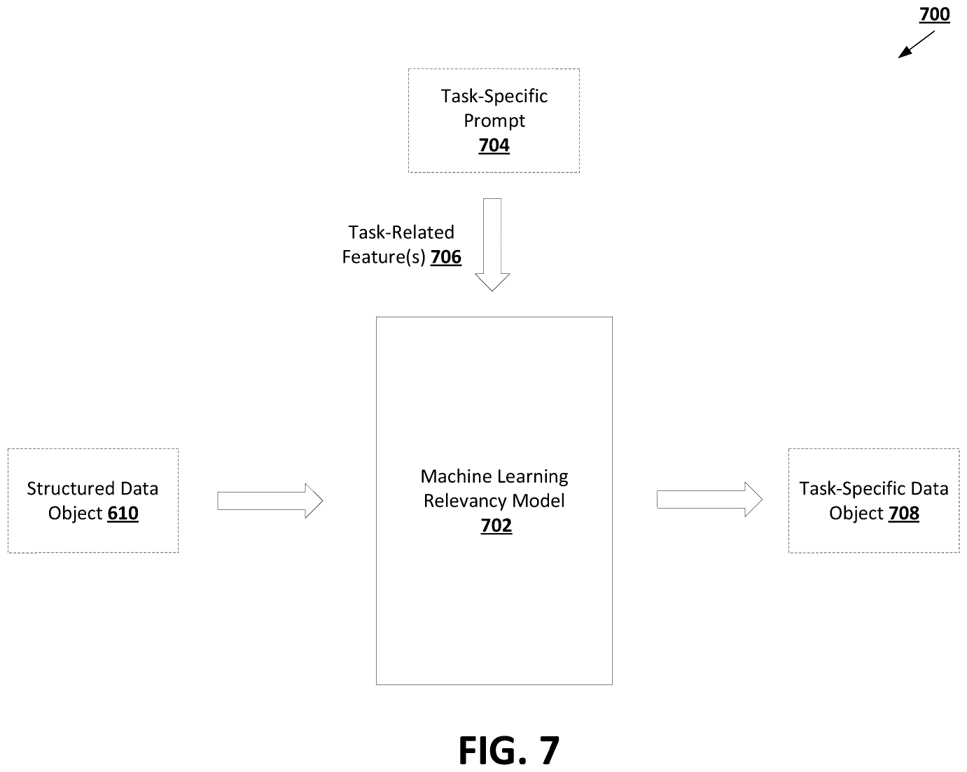

FIG. 7 illustrates an example dataflow diagram 700 related to providing machine learning relevancy functionality associated with the machine learning platform 411, in accordance with one or more embodiments of the present disclosure. The dataflow diagram 700 includes the machine learning relevancy model 702. In some embodiments, the entity representation filtering 414 may utilize the machine learning relevancy model 702 to generate a task-specific data object 708 from the structured data object 610. In some embodiments, the machine learning relevancy model 702 generate the task-specific data object 708 based on a defined domain task by filtering a plurality of task-agnostic features of the structured data object 610 using a task-specific prompt 704 that defines a set of task-related features 706. In some embodiments, the task-specific prompt 704 is a prompt data object generated based on real-time activity associated with a user interface. For example, the task-specific prompt 704 may include information provided by a user during one or more interactions with respect to a user interface of a user device. In some embodiments, the real-time activity is a real-time chatbot session associated with the machine learning relevancy model 702.

In some embodiments, the task-specific data object 708 includes one or more task-specific data elements corresponding to one or more task-specific features from the plurality of task-agnostic features. In some embodiments, a task-specific data element of the one or more task-specific data elements includes a correlation indicator that maps a task-specific feature of the one or more task-specific features to a corresponding third-party data source from the one or more third-party data sources 404. In some embodiments, a task-specific data element of the one or more task-specific data elements includes a task-specific feature value, a feature time point, the correlation indicator, and/or a relevancy indicator.

In some embodiments, the task-specific data object 708 is generated by generating, using the machine learning relevancy model 702, a plurality of relevancy scores for the plurality of task-agnostic features based on a semantic comparison between the plurality of task-agnostic features and the set of task-related features 706 defined by the task-specific prompt 704. In some embodiments, one or more task-specific features from the plurality of task-agnostic features are identified based on the plurality of relevancy scores.

In some embodiments, the machine learning relevancy model 702 and/or the machine learning formatting model 602 may be retrained based on one or more features associated with the task-specific data object 708. For example, one or more relationships between features mapped in the machine learning relevancy model 702 and/or the machine learning formatting model 602 may be adjusted (e.g., refitted) based on data associated with the task-specific data object 708. In another example, cross-validation, hyperparameter optimization, and/or regularization associated with the machine learning relevancy model 702 and/or the machine learning formatting model 602 may be adjusted based on one or more features associated with the task-specific data object 708.

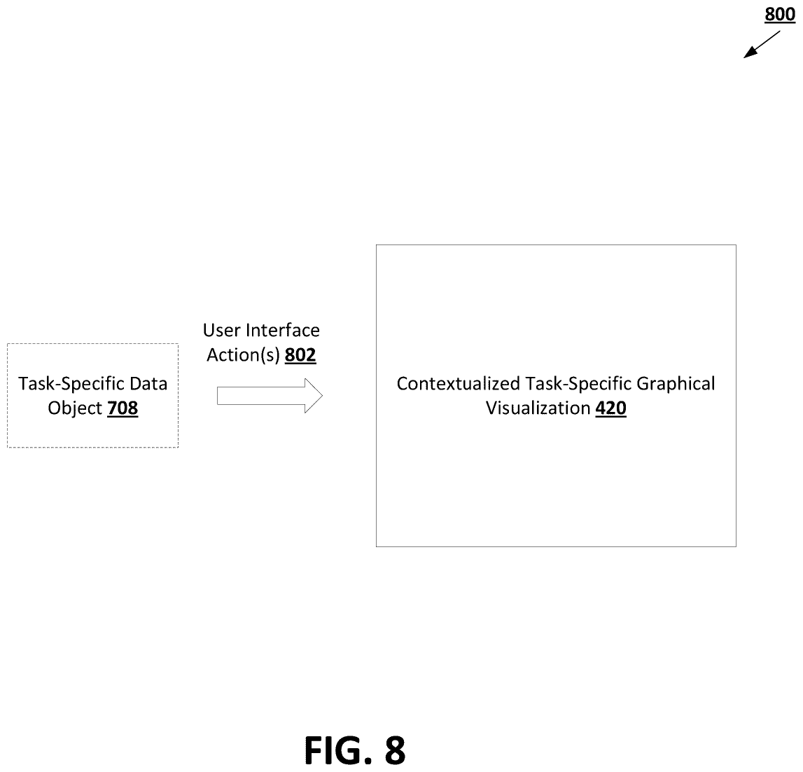

FIG. 8 illustrates an example dataflow diagram 800 related to providing user interface renderings associated with the data processing platform 402, in accordance with one or more embodiments of the present disclosure. The dataflow diagram 800 includes the contextualized task-specific graphical visualization 420. In some embodiments, one or more user interface actions 802 are performed to initiate a rendering of the contextualized task-specific graphical visualization 420 based on the task-specific data object 708. In some embodiments, the contextualized task-specific graphical visualization 420 includes an interactive timeline chart that visualizes respective data elements of the task-specific data object 708 as a function of time and/or domain features of the defined domain task. For example, in some embodiments, the contextualized task-specific graphical visualization 420 includes an interactive timeline chart that provides a grouping of data elements of the task-specific data object 708 based on a respective domain feature of the defined domain task.

In some embodiments, the one or more user interface actions 802 may include automated adjustments to a user interface to render a set of interactive graphical elements for the defined domain task via the contextualized task-specific graphical visualization 420. In some embodiments, the set of interactive graphical elements correspond to the one or more task-specific data elements. In some embodiments, an interactive graphical element corresponding to the task-specific data element is positioned within an interactive timeline chart based on the feature time point, presents the task-specific feature value, and/or includes interactive presentation features that are presented responsive to a user selection or a detected selection intent of the interactive graphical element. In some embodiments, the correlation indicator is an interactive presentation feature and/or includes an interactive link that routes an entity from the user interface to the corresponding third-party data source.

In some embodiments, the one or more user interface actions 802 may include automated instructions to a user device to initiate the rendering of the contextualized task-specific graphical visualization 420. In some embodiments, the one or more user interface actions 802 may include automated adjustments to allocations of computing resources for a user device to render the contextualized task-specific graphical visualization 420 via a user interface of the user device. Further, the one or more user interface actions 802 may additionally include automated record updating actions, automated datastore updating actions, automated server load balancing actions, automated resource allocation actions, automated alert generation actions, generating one or more electronic communications, and/or the like. The one or more user interface actions 802 may further include displaying visual renderings of the aforementioned examples of the contextualized task-specific graphical visualization 420 to render values, charts, and contextualized representations associated with the plurality of third-party data elements 405.

In some embodiments, the structured data object 610 is regenerated at a defined time interval and the rendering of the contextualized task-specific graphical visualization 420 is initiated by receiving, at a particular time point and via the user interface, a task query for an entity that identifies the defined domain task and the entity corresponding to the structured data object 610. In some embodiments, responsive to the task query, the structured data object 610 corresponding to the particular time point is received, the task-specific data object 708 is generated based on the structured data object 610, and/or the rendering of the contextualized task-specific graphical visualization 420 is initiated based on the task-specific data object 708.

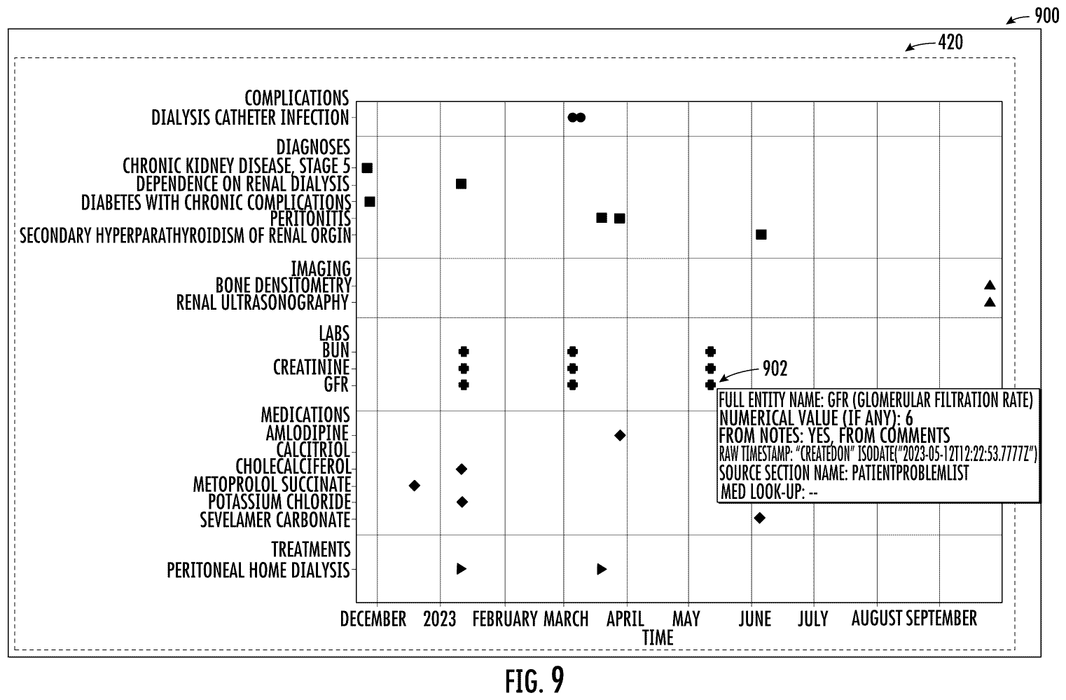

FIG. 9 illustrates an example user interface 900 for providing contextualized task-specific graphical visualizations, in accordance with one or more embodiments of the present disclosure. In one or more embodiments, the user interface 900 is, for example, an electronic interface (e.g., a graphical user interface) of the client computing entity 102. In various embodiments, the user interface 900 may be provided via the output device 316 of the client computing entity 102. The user interface 900 may be configured to render the contextualized task-specific graphical visualization 420. In various embodiments, the contextualized task-specific graphical visualization 420 may provide an interactive contextualized visualization of a task-specific data object for a defined domain task. For example, the contextualized task-specific graphical visualization 420 may render one or more interactive graphical elements related to task-specific data object. In various embodiments, the user interface 900 may be configured as a web portal interface (e.g., a medical provider portal, etc.) for managing medical decision related to a patient. In some embodiments, the is an interactive timeline chart that visualizes all the gathered and filtered patient information from the one or more third-party data sources 404 based on groupings of complications, diagnoses, imaging, labs, medications, treatments, and/or other insights as a function of time. In some embodiments, a timeframe for the interactive timeline chart may be modified and/or dynamically updated based on a drop-down menu, buttons, or another type of interactive graphical element of the user interface 900. Additionally or alternatively, a data source for contextualized task-specific graphical visualization 420 may be modified and/or dynamically updated based on a drop-down menu, buttons, or another type of interactive graphical element of the user interface 900. For example, one or more data sources for the task-specific data object and/or defined domain task may be selected by a user via drop-down menu, buttons, or another type of interactive graphical element of the user interface 900. In some embodiments, a user interaction with a particular interactive graphical element of the contextualized task-specific graphical visualization 420 such as, for example, an interactive graphical element 902, may result in rendering of a new graphical element related to information provided by one or more third-party data elements from the plurality of third-party data elements 405. For example, the new graphical element may provide a visualization related to an entity name, a numerical value, notes, a timestamp, a source name, and/or other information provided by one or more third-party data elements that are utilized to provide the interactive graphical element 902. In some embodiments, a user interaction with a particular interactive graphical element (e.g., interactive graphical element 902) may include clicking the particular interactive graphical element via the user interface 900, a cursor hovering over the particular interactive graphical element via the user interface 900, or another type of user interaction associated with the user interface 900.

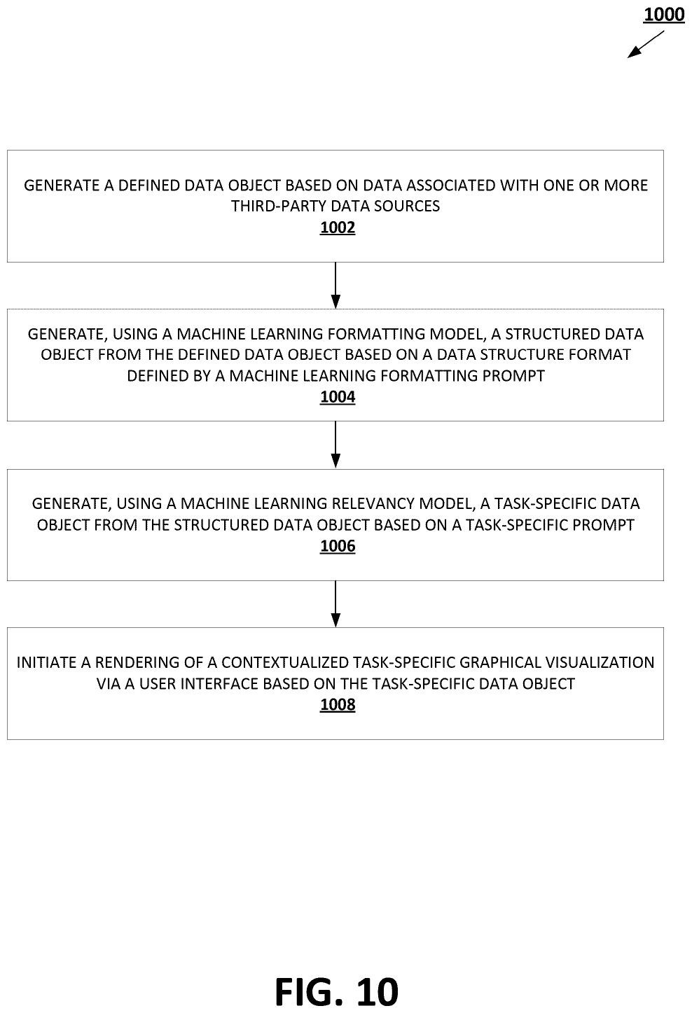

FIG. 10 is a flowchart diagram of an example process 1000 for providing a contextualized task-specific graphical visualization related to one or more third-party data sources in accordance with some embodiments discussed herein. The process 1000 may be implemented by one or more computing devices, entities, and/or systems (e.g., the computing system 101 and/or the predictive computing entity 106) described herein. For example, via the various steps/operations of the process 1000, the computing system 101 may leverage improved data processing and/or machine learning techniques to generate contextualized task-specific graphical visualization related to one or more third-party data sources. By doing so, the process 1000 enables the generation of a contextualized task-specific graphical visualization that automatically adapts to a defined domain task, while ensuring data quality in view of various data processing and/or machine learning rules.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 includes, at step/operation 1002, generating a defined data object based on data associated with one or more third-party data sources. For example, the computing system 101 may generate, using a plurality of first-party data ingestion protocols, the defined data object by transforming a plurality of third-party data elements from the one or more third-party data sources to a defined first-party format.

In some embodiments, the process 1000 includes, at step/operation 1004, generating, using a machine learning formatting model, a structured data object from the defined data object based on a data structure format defined by a machine learning formatting prompt. For example, the computing system 101 may generate, using the machine learning formatting model, the structured data object from the defined data object based on the data structure format comprising a set of format features defined by the machine learning formatting prompt.

In some embodiments, the structured data object includes a tabular format associated with respective timepoints for respective data elements of the structured data object.

In some embodiments, the process 1000 includes, at step/operation 1006, generating, using a machine learning relevancy model, a task-specific data object from the structured data object based on a task-specific prompt. For example, the computing system 101 may generate, using the machine learning relevancy model, the task-specific data object from the structured data object and corresponding to a defined domain task by filtering a plurality of task-agnostic features of the structured data object using the task-specific prompt that defines a set of task-related features.

In some embodiments, generating the task-specific data object further includes filtering the plurality of task-agnostic features of the structured data object based on a set of duplication rules that define one or more multi-tiered time-based constraints for the plurality of third-party data elements.

In some embodiments, generating the task-specific data object further includes filtering the plurality of task-agnostic features of the structured data object based on a set of data quality rules that define one or more quality constraints for the one or more third-party data sources.

In some embodiments, the task-specific data object includes one or more task-specific data elements corresponding to one or more task-specific features from the plurality of task-agnostic features. In some embodiments, a task-specific data element of the one or more task-specific data elements includes a correlation indicator that maps a task-specific feature of the one or more task-specific features to a corresponding third-party data source from the one or more third-party data sources.

In some embodiments, the task-specific data element of the one or more task-specific data elements includes a task-specific feature value, a feature time point, the correlation indicator, or a relevancy indicator.

In some embodiments, the set of interactive graphical elements correspond to the one or more task-specific data elements. In some embodiments, an interactive graphical element corresponding to the task-specific data element is positioned within an interactive timeline chart based on the feature time point. In some embodiments, an interactive graphical element corresponding to the task-specific data element additionally or alternatively presents the task-specific feature value. In some embodiments, an interactive graphical element corresponding to the task-specific data element additionally or alternatively includes interactive presentation features that are presented responsive to a user selection or a detected selection intent of the interactive graphical element.

In some embodiments, the correlation indicator is an interactive presentation feature and/or includes an interactive link that routes an entity from the user interface to the corresponding third-party data source.

In some embodiments, the task-specific data object is generated by generating, using the machine learning relevancy model, a plurality of relevancy scores for the plurality of task-agnostic features based on a semantic comparison between the plurality of task-agnostic features and the set of task-related features defined by the task-specific prompt. In some embodiments, the task-specific data object is additionally or alternatively generated by identifying one or more task-specific features from the plurality of task-agnostic features based on the plurality of relevancy scores.

In some embodiments, the process 1000 includes, at step/operation 1008, initiate a rendering of a contextualized task-specific graphical visualization via a user interface based on the task-specific data object. For example, the computing system 101 may initiate, via a user interface, the rendering of the contextualized task-specific graphical visualization that is based on the task-specific data object and comprises a set of interactive graphical elements for the defined domain task.

In some embodiments, the structured data object is regenerated at a defined time interval. Additionally, in some embodiments, initiating the rendering of the contextualized task-specific graphical visualization includes receiving, at a particular time point and via the user interface, a task query for an entity that identifies the defined domain task and the entity corresponding to the structured data object. In some embodiments, responsive to the task query, the computing system 101 may receive the structured data object corresponding to the particular time point, generate the task-specific data object based on the structured data object, and/or initiate the rendering of the contextualized task-specific graphical visualization based on the task-specific data object.

Some techniques of the present disclosure enable the generation of action outputs that may be performed to initiate one or more real world actions to achieve real-world effects. The data processing and machine learning techniques of the present disclosure may be used, applied, and/or otherwise leveraged to generate reliable data objects, which may help in the creation and provisioning of messages across computing entities, as well as other downstream tasks such as rendering of a visualization via a user interface. For instance, generative output, using some of the techniques of the present disclosure, may trigger the performance of actions at a client device, such as the display, transmission, and/or the like of data reflective of a contextualized task-specific graphical visualization. In some embodiments, the contextualized task-specific graphical visualization may trigger an alert via a user interface.

In some examples, the computing tasks may include actions that may be based on a defined domain task. A defined domain task may include any environment in which computing systems may be applied to generate a contextualized task-specific graphical visualization and initiate the performance of computing tasks responsive to a contextualized task-specific graphical visualization. These actions may cause real-world changes, for example, by controlling a hardware component of a user device or a server device, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: generating, by one or more processors and using a plurality of first-party data ingestion protocols, a defined data object by transforming a plurality of third-party data elements from one or more third-party data sources to a defined first-party format; generating, by the one or more processors and using a machine learning formatting model, a structured data object from the defined data object based on a data structure format comprising a set of format features defined by a machine learning formatting prompt; generating, by the one or more processors and using a machine learning relevancy model, a task-specific data object from the structured data object and corresponding to a defined domain task by filtering a plurality of task-agnostic features of the structured data object using a task-specific prompt that defines a set of task-related features; and initiating, by the one or more processors and via a user interface, a rendering of a contextualized task-specific graphical visualization that is based on the task-specific data object and comprises a set of interactive graphical elements for the defined domain task.

Example 2. The computer-implemented method of example 1, wherein the structured data object is regenerated at a defined time interval, and initiating the rendering of the contextualized task-specific graphical visualization comprises: receiving, at a particular time point and via the user interface, a task query for an entity that identifies the defined domain task and the entity corresponding to the structured data object; and responsive to the task query, receiving the structured data object corresponding to the particular time point, generating the task-specific data object based on the structured data object, and initiating the rendering the contextualized task-specific graphical visualization based on the task-specific data object.

Example 3. The computer-implemented method of any of the above examples, wherein generating the task-specific data object further comprises: filtering the plurality of task-agnostic features of the structured data object based on a set of duplication rules that define one or more multi-tiered time-based constraints for the plurality of third-party data elements.

Example 4. The computer-implemented method of any of the above examples, wherein generating the task-specific data object further comprises: filtering the plurality of task-agnostic features of the structured data object based on a set of data quality rules that define one or more quality constraints for the one or more third-party data sources.

Example 5. The computer-implemented method of any of the above examples, wherein: (i) the task-specific data object comprises one or more task-specific data elements corresponding to one or more task-specific features from the plurality of task-agnostic features, and (ii) a task-specific data element of the one or more task-specific data elements comprises a correlation indicator that maps a task-specific feature of the one or more task-specific features to a corresponding third-party data source from the one or more third-party data sources.

Example 6. The computer-implemented method of any of the above examples, wherein a task-specific data element of the one or more task-specific data elements comprises a task-specific feature value, a feature time point, the correlation indicator, a relevancy indicator.

Example 7. The computer-implemented method of any of the above examples, wherein the set of interactive graphical elements correspond to the one or more task-specific data elements, and an interactive graphical element corresponding to the task-specific data element: (i) is positioned within an interactive timeline chart based on the feature time point, (ii) presents the task-specific feature value, and (iii) comprises interactive presentation features that are presented responsive to a user selection or a detected selection intent of the interactive graphical element.

Example 8. The computer-implemented method of any of the above examples, wherein the correlation indicator is an interactive presentation feature and comprises an interactive link that routes an entity from the user interface to the corresponding third-party data source.

Example 9. The computer-implemented method of any of the above examples, wherein the structured data object comprises a tabular format associated with respective timepoints for respective data elements of the structured data object.

Example 10. The computer-implemented method of claim of any of the above examples, wherein the task-specific data object is generated by: generating, using the machine learning relevancy model, a plurality of relevancy scores for the plurality of task-agnostic features based on a semantic comparison between the plurality of task-agnostic features and the set of task-related features defined by the task-specific prompt; and identifying one or more task-specific features from the plurality of task-agnostic features based on the plurality of relevancy scores.

Example 11. A computing system comprising memory and one or more processors communicatively coupled to the memory, the one or more processors configured to: generate, using a plurality of first-party data ingestion protocols, a defined data object by transforming a plurality of third-party data elements from one or more third-party data sources to a defined first-party format; generate, using a machine learning formatting model, a structured data object from the defined data object based on a data structure format comprising a set of format features defined by a machine learning formatting prompt; generate, using a machine learning relevancy model, a task-specific data object from the structured data object and corresponding to a defined domain task by filtering a plurality of task-agnostic features of the structured data object using a task-specific prompt that defines a set of task-related features; and initiate, via a user interface, a rendering of a contextualized task-specific graphical visualization that is based on the task-specific data object and comprises a set of interactive graphical elements for the defined domain task.

Example 12. The computing system of example 11, wherein the structured data object is regenerated at a defined time interval, and the one or more processors further configured to: receive, at a particular time point and via the user interface, a task query for an entity that identifies the defined domain task and the entity corresponding to the structured data object; and responsive to the task query, receive the structured data object corresponding to the particular time point, generate the task-specific data object based on the structured data object, and initiate the rendering the contextualized task-specific graphical visualization based on the task-specific data object.

Example 13. The computing system of any of the above examples, wherein the one or more processors are further caused to: filter the plurality of task-agnostic features of the structured data object based on a set of duplication rules that define one or more multi-tiered time-based constraints for the plurality of third-party data elements.

Example 14. The computing system of any of the above examples, wherein the one or more processors are further caused to: filter the plurality of task-agnostic features of the structured data object based on a set of data quality rules that define one or more quality constraints for the one or more third-party data sources.

Example 15. The computing system of any of the above examples, wherein: (i) the task-specific data object comprises one or more task-specific data elements corresponding to one or more task-specific features from the plurality of task-agnostic features, and (ii) a task-specific data element of the one or more task-specific data elements comprises a correlation indicator that maps a task-specific feature of the one or more task-specific features to a corresponding third-party data source from the one or more third-party data sources.

Example 16. The computing system of any of the above examples, wherein a task-specific data element of the one or more task-specific data elements comprises a task-specific feature value, a feature time point, the correlation indicator, a relevancy indicator.

Example 17. The computing system of any of the above examples, wherein the set of interactive graphical elements correspond to the one or more task-specific data elements, and an interactive graphical element corresponding to the task-specific data element: (i) is positioned within an interactive timeline chart based on the feature time point, (ii) presents the task-specific feature value, and (iii) comprises interactive presentation features that are presented responsive to a user selection or a detected selection intent of the interactive graphical element.

Example 18. The computing system of any of the above examples, wherein the correlation indicator is an interactive presentation feature and comprises an interactive link that routes an entity from the user interface to the corresponding third-party data source.

Example 19. The computing system of any of the above examples, wherein the structured data object comprises a tabular format associated with respective timepoints for respective data elements of the structured data object.

Example 20. One or more non-transitory computer-readable storage media including instructions that, when executed by one or more processors, cause the one or more processors to: generate, using a plurality of first-party data ingestion protocols, a defined data object by transforming a plurality of third-party data elements from one or more third-party data sources to a defined first-party format; generate, using a machine learning formatting model, a structured data object from the defined data object based on a data structure format comprising a set of format features defined by a machine learning formatting prompt; generate, using a machine learning relevancy model, a task-specific data object from the structured data object and corresponding to a defined domain task by filtering a plurality of task-agnostic features of the structured data object using a task-specific prompt that defines a set of task-related features; and initiate, via a user interface, a rendering of a contextualized task-specific graphical visualization that is based on the task-specific data object and comprises a set of interactive graphical elements for the defined domain task.

1. A computer-implemented method comprising:
generating, by one or more processors and using a plurality of first-party data ingestion protocols, a defined data object by transforming a plurality of third-party data elements from one or more third-party data sources to a defined first-party format;
generating, by the one or more processors and using a machine learning formatting model, a structured data object from the defined data object based on a data structure format comprising a set of format features defined by a machine learning formatting prompt;
generating, by the one or more processors and using a machine learning relevancy model, a task-specific data object from the structured data object and corresponding to a defined domain task by filtering a plurality of task-agnostic features of the structured data object using a task-specific prompt that defines a set of task-related features; and
initiating, by the one or more processors and via a user interface, a rendering of a contextualized task-specific graphical visualization that is based on the task-specific data object and comprises a set of interactive graphical elements for the defined domain task.

2. The computer-implemented method of claim 1, wherein the structured data object is regenerated at a defined time interval, and initiating the rendering of the contextualized task-specific graphical visualization comprises:
receiving, at a particular time point and via the user interface, a task query for an entity that identifies the defined domain task and the entity corresponding to the structured data object; and
responsive to the task query,
receiving the structured data object corresponding to the particular time point,
generating the task-specific data object based on the structured data object, and
initiating the rendering of the contextualized task-specific graphical visualization based on the task-specific data object.

3. The computer-implemented method of claim 1, wherein generating the task-specific data object further comprises:
filtering the plurality of task-agnostic features of the structured data object based on a set of duplication rules that define one or more multi-tiered time-based constraints for the plurality of third-party data elements.

4. The computer-implemented method of claim 1, wherein generating the task-specific data object further comprises:
filtering the plurality of task-agnostic features of the structured data object based on a set of data quality rules that define one or more quality constraints for the one or more third-party data sources.

5. The computer-implemented method of claim 1, wherein:
(i) the task-specific data object comprises one or more task-specific data elements corresponding to one or more task-specific features from the plurality of task-agnostic features, and
(ii) a task-specific data element of the one or more task-specific data elements comprises a correlation indicator that maps a task-specific feature of the one or more task-specific features to a corresponding third-party data source from the one or more third-party data sources.

6. The computer-implemented method of claim 5, wherein the task-specific data element of the one or more task-specific data elements comprises a task-specific feature value, a feature time point, the correlation indicator, or a relevancy indicator.

7. The computer-implemented method of claim 6, wherein the set of interactive graphical elements correspond to the one or more task-specific data elements, and an interactive graphical element corresponding to the task-specific data element:
(i) is positioned within an interactive timeline chart based on the feature time point,
(ii) presents the task-specific feature value, and
(iii) comprises interactive presentation features that are presented responsive to a user selection or a detected selection intent of the interactive graphical element.

8. The computer-implemented method of claim 7, wherein the correlation indicator is an interactive presentation feature and comprises an interactive link that routes an entity from the user interface to the corresponding third-party data source.

9. The computer-implemented method of claim 1, wherein the structured data object comprises a tabular format associated with respective timepoints for respective data elements of the structured data object.

10. The computer-implemented method of claim of claim 1, wherein the task-specific data object is generated by:
generating, using the machine learning relevancy model, a plurality of relevancy scores for the plurality of task-agnostic features based on a semantic comparison between the plurality of task-agnostic features and the set of task-related features defined by the task-specific prompt; and
identifying one or more task-specific features from the plurality of task-agnostic features based on the plurality of relevancy scores.

11. A computing system comprising memory and one or more processors communicatively coupled to the memory, the one or more processors configured to:
generate, using a plurality of first-party data ingestion protocols, a defined data object by transforming a plurality of third-party data elements from one or more third-party data sources to a defined first-party format;
generate, using a machine learning formatting model, a structured data object from the defined data object based on a data structure format comprising a set of format features defined by a machine learning formatting prompt;
generate, using a machine learning relevancy model, a task-specific data object from the structured data object and corresponding to a defined domain task by filtering a plurality of task-agnostic features of the structured data object using a task-specific prompt that defines a set of task-related features; and
initiate, via a user interface, a rendering of a contextualized task-specific graphical visualization that is based on the task-specific data object and comprises a set of interactive graphical elements for the defined domain task.

12. The computing system of claim 11, wherein the structured data object is regenerated at a defined time interval, and the one or more processors further configured to:
receive, at a particular time point and via the user interface, a task query for an entity that identifies the defined domain task and the entity corresponding to the structured data object; and
responsive to the task query,
receive the structured data object corresponding to the particular time point,
generate the task-specific data object based on the structured data object, and
initiate the rendering of the contextualized task-specific graphical visualization based on the task-specific data object.

13. The computing system of claim 11, wherein the one or more processors are further caused to:
filter the plurality of task-agnostic features of the structured data object based on a set of duplication rules that define one or more multi-tiered time-based constraints for the plurality of third-party data elements.

14. The computing system of claim 11, wherein the one or more processors are further caused to:
filter the plurality of task-agnostic features of the structured data object based on a set of data quality rules that define one or more quality constraints for the one or more third-party data sources.

15. The computing system of claim 11, wherein:
(i) the task-specific data object comprises one or more task-specific data elements corresponding to one or more task-specific features from the plurality of task-agnostic features, and
(ii) a task-specific data element of the one or more task-specific data elements comprises a correlation indicator that maps a task-specific feature of the one or more task-specific features to a corresponding third-party data source from the one or more third-party data sources.

16. The computing system of claim 15, wherein the task-specific data element of the one or more task-specific data elements comprises a task-specific feature value, a feature time point, the correlation indicator, or a relevancy indicator.

17. The computing system of claim 16, wherein the set of interactive graphical elements correspond to the one or more task-specific data elements, and an interactive graphical element corresponding to the task-specific data element:
(i) is positioned within an interactive timeline chart based on the feature time point,
(ii) presents the task-specific feature value, and
(iii) comprises interactive presentation features that are presented responsive to a user selection or a detected selection intent of the interactive graphical element.

18. The computing system of claim 17, wherein the correlation indicator is an interactive presentation feature and comprises an interactive link that routes an entity from the user interface to the corresponding third-party data source.

19. The computing system of claim 18, wherein the structured data object comprises a tabular format associated with respective timepoints for respective data elements of the structured data object.

20. One or more non-transitory computer-readable storage media including instructions that, when executed by one or more processors, cause the one or more processors to:
generate, using a plurality of first-party data ingestion protocols, a defined data object by transforming a plurality of third-party data elements from one or more third-party data sources to a defined first-party format;
generate, using a machine learning formatting model, a structured data object from the defined data object based on a data structure format comprising a set of format features defined by a machine learning formatting prompt;
generate, using a machine learning relevancy model, a task-specific data object from the structured data object and corresponding to a defined domain task by filtering a plurality of task-agnostic features of the structured data object using a task-specific prompt that defines a set of task-related features; and
initiate, via a user interface, a rendering of a contextualized task-specific graphical visualization that is based on the task-specific data object and comprises a set of interactive graphical elements for the defined domain task.
